(19) United States
(12) Patent Application Publication
(10) Pub. No.: US 2017/0087657 A1
(43) Pub. Date: Mar. 30, 2017

(54) METHOD AND APPARATUS FOR UNIFORMLY COATING A METALLIC OR METALLIZED BRAIDED HOSE

(71) Applicant: FEW FAHRZEUGELEKTRIKWERK GMBH & CO. KG, Zwenkau (DE)

(72) Inventors: WERNER HARTMANN, LEIPZIG (DE); DANIELA BEESE, PEGAU (DE)

(21) Appl. No.: 15/126,455

(22) PCT Filed: Feb. 26, 2015
(86) PCT No.: PCT/EP2015/054054

§ 371 Date: Sep. 15, 2016

(30) Foreign Application Priority Data
Mar. 19, 2014 (DE) 10 2014 003 904.8
Apr. 14, 2014 (DE) 10 2014 005 494.2

(51) Int. Cl. B23K 1/00; H01B 5/12; H01B 13/00; H01B 1/02

(52) U.S. Cl. CPC B23K 1/0008; H01B 1/02; H01B 5/12; H01B 13/0036

(57) ABSTRACT

The invention relates to a method for uniformly coating a metallic or metallised braided hose, in particular a stranded braided hose with a solder or a soldering and fluxing agent. According to the invention, the solder is provided in bar or tubular form, wherein the outer diameter or the cross-sectional area of the bar or the tube is chosen to be less than the inner diameter or the inner cross-sectional area of the braided hose. Furthermore, the solder is pushed into at least one longitudinal portion of the braided hose and the solder is fixed in the braided hose cavity. Further processing of the braided hose, in particular heating to the melting point of the solder introduced, can then be performed in a generally known way.

The invention relates to a method and an apparatus for uniformly coating a metallic or metallised braided hose, especially a stranded braided hose with a solder or a soldering and fluxing agent according to the preamble of claim 1 or 11. The apparatus further relates to a metallic braided hose, especially a stranded braided hose with a quantity of soldering agent or solder-fluxing agent combination disposed in the interior of the hose.

Known stranded braids consist of a metallic braided hose, especially a woven copper which is rolled with respect to width and height according to the customers requirements. Stranded braids can be produced by using technologies generally used in the textile field, i.e. on the basis of weaving methods, and show high flexibility and, according to dimensioning, sufficient current-capacity and low ohmic resistance.

Stranded braided conductors are especially used in electrical devices and apparatuses, especially also in cases where contact needs to be made with moved parts and/or in cases where there is a high mechanical vibrating load.

For the purpose of maintaining secure materially bonded connections, especially soldered connections in the formation of respective contacts, a strip conductor must be sufficiently tin-plated and provided with a fluxing agent. Technologies known in this respect for roller application of solder lead to inadequate adherence in the preliminary manufacturing process and to undesirable formation of bubbles in soldering. Tin-plating in the liquid tin bath often leads to the disadvantage that the tin quantity is insufficiently or irregularly distributed. Furthermore, the fluxing agent needs to be applied separately in this case. Finally, a pre-tinned strand is not weldable, which is disadvantageous when a rigid mechanical contact or a plug connector or a similar means needs to be applied by welding to the stranded braid.

A cored solder wire is already known from DE 10 2009 033 406 A1. Said cored solder wire consists of a solder material in form of a hollow wire. The hollow wire per se is filled with a core made of a special fluxing agent. Such a cored solder wire is very practical as a result of the fluxing agent and integrated in the solder and is easy to use. As a result of the adjustable quantity between the solder material and the fluxing agent, an optimal ratio is available for the respective soldering process or for the consideration of the soldering alloy.

A soldering agent is further known from DE 20 2007 002 140 U1 for use in soft-soldering, comprising a massive form of a soft-solder material whose outer surface is provided over a portion of the surface or the entire surface with a bonded and non-adhesive coating made of a fluxing agent that does not act corrosively.

In the method for soldering connecting wires onto ceramic components in particular according to DE 196 36 577 C1, a soldering tape is applied to the connecting wire to be soldered prior to the soldering on. The soldering tape per se is provided with a fluxing agent and is applied to the connecting wire by using an apparatus by means of a mechanical bending process. A precisely definable solder quantity is achieved by a respective soldering tape width and thickness by applying the soldering tape filled with a fluxing agent to the connecting wire to be soldered, whereas on the other hand a precise position of the solder is provided. A separate application of fluxing agent is not necessary because the fluxing agent per se is situated within the soldering tape.

A soldering agent application apparatus is known from DE 689 15 543 T2, which shall at least partly render classic pre-tinning unnecessary. A flat body is present in this respect which comprises a folding line. A quantity of solder is further positioned on the flat body. The flat body can be applied onto or close to the surface of an object by folding. It is additionally ensured that the heated solder flows in a defined direction perpendicularly to the weakening line or folding line. The prior known apparatus is to be especially suitable for applying solder to flat objects, namely especially for applying solder to an arrangement of electrical conductors in form of stripped flat conductors of square or rectangular cross-section. The solder situated on the flat body preferably comprises a suitable fluxing agent and comprises an adhesive which has the function of keeping the apparatus in its position when a heating process occurs in order to make the solder melt and flow.

It is thus a common feature of the known methods and apparatuses that usually the soldering alloy or the soldering agent plus the fluxing agent are applied from the outside to an electrical conductor or contact. This is certainly effective in conventional rigid conductors or stranded conductors with the capillary forces which are effective in the latter case. In the case of stranded braided conductors however the known techniques lead to problems with the consequence that additional solder depots need to be provided or re-tinning is necessary. A further problem arises in that the pre-tinned stranded braid materials cannot be connected by welding to contacts, especially vehicle plug contacts or the like.

It is therefore the object of the invention from the aforementioned statements to provide a further developed method for the uniform coating of a metallic or metallised braided hose, especially a stranded braided hose with a solder or a soldering and fluxing agent, which minimises the quantity of solder to be used, which further does not disadvantageously influence the welding on of electrical contacts and makes the provision of individual solder depots superfluous.

It is a further object of the invention to provide a suitable apparatus for carrying out the method to be provided.

This object is achieved in accordance with the invention in respect of the method by the teachings according to the definition of claim 1 and in respect of the apparatus by the feature combination according to claim 11, wherein claim 9 is directed to the product in accordance with the invention in form of a metallic or metallised braided hose.

The method is therefore based on a uniform coating of a metallic or metallised braided hose, especially a stranded braided hose, for electrical purposes with a solder or a solder-fluxing agent combination. The uniform coating can directly be the result of the method in accordance with the invention or a subsequent treatment step, especially the heating of the solder or the applied soldering alloy. It is relevant according to the invention to provide in a purposeful manner a technologically optimal solder quantity plus fluxing agent, without having to make use in the actual soldering process of a supplementary solder which needs to be supplied separately, or without requiring any other solder depot.

It is the fundamental concept of the invention to provide the actual solder in form of bars or tubes, wherein the outer diameter or the cross-sectional area of the bar or the solder tube must be selected smaller than the internal diameter or the internal cross-sectional area of the braided hose.

The solder is inserted in form of a bar or tube into a longitudinal section of the cavity of the braided hose by taking the aforementioned condition into account and is fixed in the cavity of the braided hose.

The known further processing of the braided hose, especially the heating up to the melting point of the introduced solder, can occur subsequently. Said heating process can be carried out during the treatment of the stranded braided hose, but also when using the braided hose for making contact with a contact agent on a vehicle pane.

It is possible in accordance with the invention to either insert a respective longitudinal portion of solder in the region of the cut sections of the metallic braided hose or to fill only the end sections with inserted solder, wherein other sections of the braided hose remain free and can be used for crimping tabs, for welding with plug contacts or the like.

Reproducible conditions for the later soldering and/or tinning are always provided by the selection of the length and the diameter or cross-section of the solder to be introduced in addition to the fluxing agent, relating to the respective dimensions of the braided hose or stranded braided conductor. Respective errors in the soldering process can be excluded.

For the purpose of easier introduction of the solder in bar or tubular form, the braided hose can be mechanically loaded for opening and widening its cavity. A stranded braid can thus be subjected to widening by a pressure force.

A mandrel can be used in accordance with the invention for inserting the solder, which mandrel is introduced into a front opening region of the braided hose or is moved toward said opening region, wherein the solder is introduced into the cavity via an opening situated in the mandrel.

This embodiment also offers the possibility that the solder reaches the interior of the cavity of the braided hose with a respective viscosity, e.g. viscous via the mandrel, which in this case also acts as a nozzle. It can also be considered that the solder or solder-fluxing agent mixture is provided in pasty form and is introduced in said pasty state into the braided hose and is subjected there to a certain amount of hardening.

Alternatively, the braided hose can be pushed over the bar-shaped or tubular solder in a quasi kinematic reversal. A pressing or pressure force for deforming the braided hose and fixing the solder can be applied to the braided hose after the aforementioned steps.

The insertion of the solder and/or the opening of the cross-sectional area of the cavity of the braided hose can also be carried out with the support of compressed air.

As already mentioned, a fluxing agent can be added to the solder. When using a cored solder wire, the fluxing agent is disposed in a defined quantity in the interior of the cored solder wire and forms its core.

Prior to the introduction of solder into the braided hose, at least one electrical contact can be connected to the braided hose, especially welded onto said hose.

A metallic or metallised braided hose is provided in accordance with the invention, especially a stranded braided hose with a quantity of solder or solder-fluxing agent combination which is disposed in the interior of the hose and extends over at least one longitudinal section of the hose.

Said quantity of solder-fluxing agent combination is preferably a cored solder wire with the aforementioned core made of fluxing agent.

An apparatus is used for carrying out the method in accordance with the invention, which apparatus comprises at first a receiving unit for a metallic or metallised, electrically conductive braided hose. It is ensured by means of the receiving unit that a cross-sectional opening of one end of the cavity of the hose is freely exposed.

A solder feed mandrel is further formed, which can be moved with its mandrel tip to the cross-sectional opening.

A cored solder wire can be introduced mechanically into the cavity of the hose via the interior of the solder wire feeding mandrel.

Furthermore, at least one roller or press is provided for exerting a deformation force in order to obtain a fixed mechanical bond between the cored solder wire and the braided hose. Furthermore, means are provided for cutting the created bond to length.

The invention will be explained below in closer detail by reference to an embodiment shown in the drawing, wherein:

FIGS. 1a) to c) show a cross-sectional view of a conventional stranded braid in rectangular form, the rectangular stranded braid in the pressed form for obtaining access to the interior of the strand and a stranded braided hose of quasi-circular cross-section;

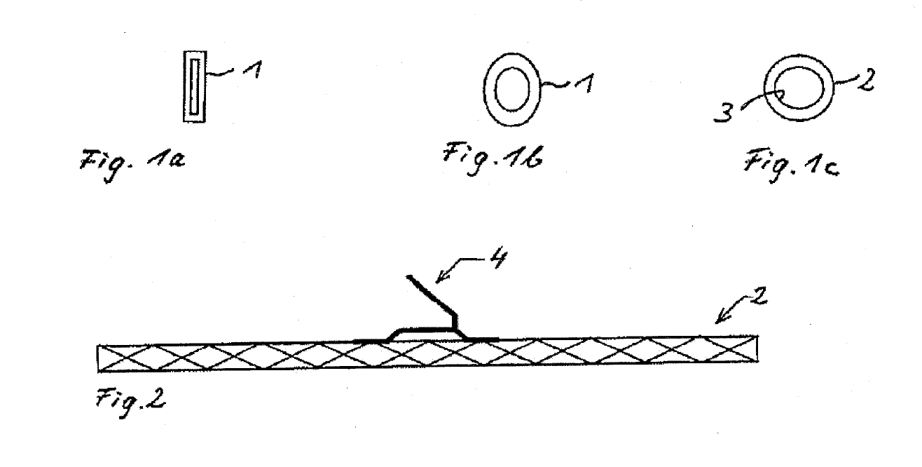

FIG. 2 shows a longitudinal sectional view of a braided hose with a flat plug contact that is welded onto said hose;

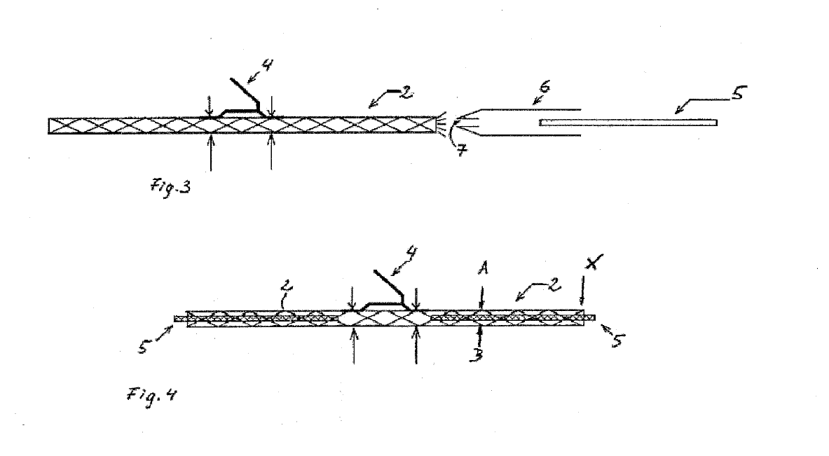

FIG. 3 shows a longitudinal sectional view of the braided hose with contact and a soldering wire feed mandrel and a cored soldering wire;

FIG. 4 shows a longitudinal view of the completed structure with the solder introduced into the interior of the braided hose prior to pressing;

FIG. 5 shows a view similar to that of FIG. 4, but after pressing;

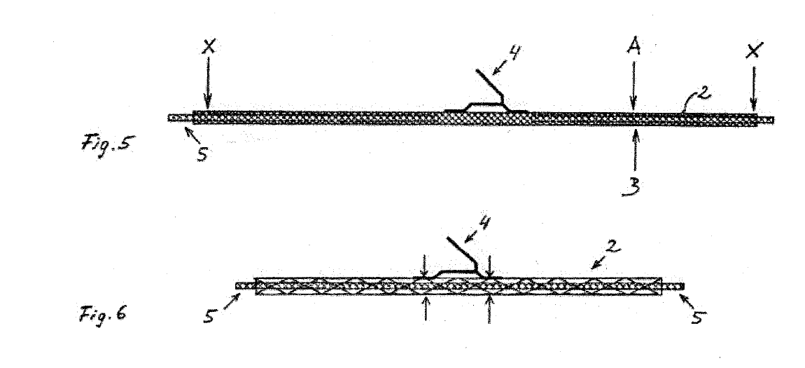

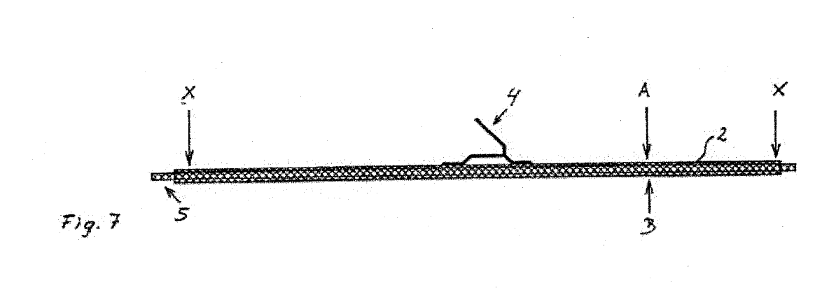

FIG. 6 shows a longitudinal view of the completed structure according to the second embodiment with a continuous cored solder wire which is introduced into the interior of the braided hose;

FIG. 7 shows a view similar to that of FIG. 6, but after pressing, and

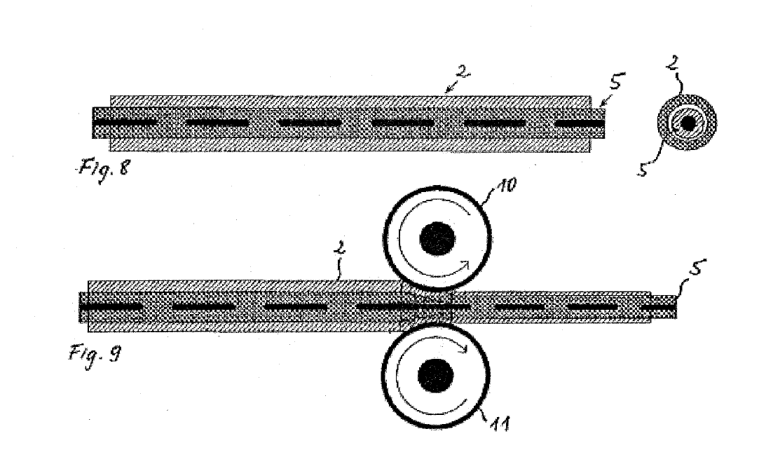

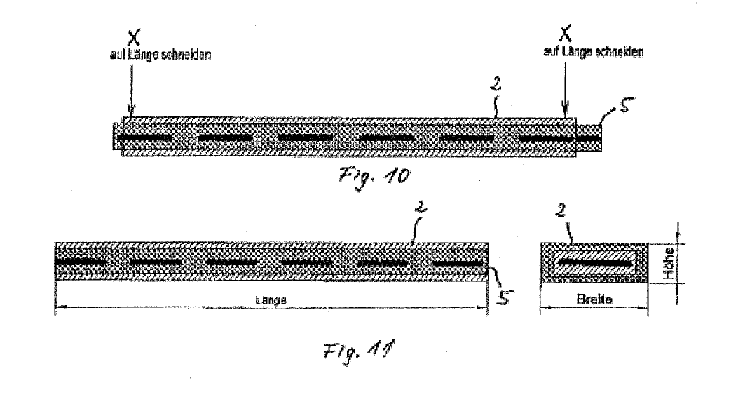

FIGS. 8 to 11 show longitudinal sectional views of a braided hose in accordance with the invention, wherein the cored solder wire is introduced into the interior of the braided hose according to FIG. 8, pressing or rolling of the braided hose with respect to height and width with the cored solder wire disposed in the interior thereof is carried out according to FIG. 9, and the pressed structure is cut to length according to FIG. 10, and the completed stranded braided structure is available for further processing according to FIG. 11 (longitudinal sectional view and cross-sectional view).

FIG. 1a shows a classic stranded braid 1 of rectangular cross-section. The stranded braid 1 can be brought to a state where it is pressed apart as a result of action of pressure forces in the direction of the centre of gravity of the cross-sectional surface, as shown in FIG. 1b. A braided hose 2 according to FIG. 1c has a substantially circular cross-section with a circular cavity 3.

Such a cavity, in approximated braided shape, is also obtained after pressing apart the stranded braid 1 according to FIG. 1b.

As is shown in the schematic illustration in FIG. 2, a rigid contact 4 can be applied to the braided hose 2 by welding to the surface.

The illustration according to FIG. 3 shows how a solder 5 in bar or tubular shape, especially a so-called cored solder wire, can be introduced by means of the solder feed mandrel 6 into the cavity 3 of the braided hose 2.

Specifically, the solder 5 is inserted into and pushed through the cavity 3 of the braided hose 2 via the mandrel 6 which has an opening 7.

The result of such treatment is shown in FIG. 4.

By applying a pressing force in the direction of the illustrated arrows A and B, the braided hose 2 is brought to its final form, e.g. stranded braided form of rectangular cross-section, and the cored solder wire 5 is simultaneously fixed in the interior. The braided hose 2 can be cut to length at the points X in the known manner.

With the solution described in the embodiment, the customer's wish can be fulfilled for providing stranded braid contacts for heating fields without solder depots for the soldering of contacts to motor-vehicle panes for example. The stranded braid is fully provided with tin in the inner volume after the application of a contact by welding, so that easy soldering is possible on the aforementioned vehicle pane and the contact surface provided there. A stranded braid in form of a copper stranded braided hose is pressed at the opposite ends, as shown in the illustration (FIG. 1b), and pushed onto the perforated guide mandrel or mandrel tip. The solder can then be inserted via the mandrel adjusted to the diameter into the copper stranded braided hose. There is no subsequent fluxing because the inserted solder concerns a cored solder wire with a fluxing agent.

The copper stranded braided hose is cut to length after rolling or pressing to height and width (see FIGS. 5 and 7). It is understood that a round stranded hose (see FIG. 1c) of respective cross-section can be processed, which further simplifies the production of the stranded braid contacts.

Since no heating is necessary for introducing the tin into the interior of the braided hose or the stranded braids, energy is saved and clean work can be provided.

In the embodiment according to FIGS. 4 and 5, the cored solder wire 5 is not introduced continuously into the braided hose 2. The region in which the contact 4 is attached can remain free with respect to the cored solder wire 5.

In the embodiment according to FIGS. 6 and 7 on the other hand, the cored solder wire 5 extends through the entire interior of the braided hose 2, which is advantageous in classic soldering of the contact 4.

The method for providing the metallised braided hose or stranded braided hose in accordance with the invention will be explained in closer detail by reference to FIGS. 8 to 11.

A classic braided hose 2 is provided in the interior with the cored solder wire 5, optionally after respective widening. The cross-sectional view (illustration on the right-hand side in FIG. 8) shows that a free space remains between the outer diameter of the cored solder wire 5 and the inner diameter of the braided hose 2 for the purpose of easy introduction of the cored solder wire 5.

In the following step according to FIG. 9, the structure consisting of the braided hose 2 with the cored solder wire 5 situated in the interior thereof is rolled by means of a pair of rollers 10 and 11 to width or, by reverting to a lateral stop or a lateral roller (not shown in the illustration), to width and height, i.e. it is subjected to pressing. As a result, the cored solder wire 5 is thus securely fixed in the interior of the braided hose 2 on the one hand and the desired strip structure of the braided hose 2 can be produced on the other hand.

The structure pressed and rolled in this respect is cut to length according to the technical and customer requirements and is then available for further processing, as shown in FIG. 11 in a longitudinal and cross-sectional view.

1. A method for uniformly coating a metallic or metallised braided hose, especially a stranded braided hose with a solder or a soldering and fluxing agent, characterized in that the solder is provided in bar or tubular form (5), wherein the outer diameter or cross-sectional surface area of the bar or the tube is selected smaller than the inner diameter or the inner cross-sectional surface area of the braided hose (1), with subsequent inserting of the solder (5) into at least one longitudinal section of a cavity (3) of the braided hose, wherein the braided hose (2) is mechanically loaded and widened for opening the cavity (3), fixing of the solder (5) in the cavity (3) of the braided hose, and known further processing of the braided hose (2), especially heating up to the melting point of the introduced solder.

2. A method according to claim 1, characterized in that a mandrel (6) is introduced into a front opening region of the braided hose (1; 2) for the insertion of the solder (5), wherein the solder (5) is introduced into the cavity (3) via an opening (7) situated in the mandrel (6).

3. A method according to claim 1, characterized in that the braided hose (1;
2) is pushed over the bar-shaped or tubular solder (5), and a pressing or pressure force (A; B) is subsequently applied to the braided hose (1; 2) for the deformation of the braided hose (2) and fixing of the solder (5).

4. A method according to claim 1, characterized in that the insertion of the solder (5) occurs with the support of compressed air.

5. A method according to claim 1, characterized in that a fluxing agent is mixed into or added to the solder.

6. A method according to claim 1, characterized in that the cored solder wire (5) comprises a fluxing agent in its interior.

7. A method according to claim 1, characterized in that prior to the introduction of solder into the braided hose at least one electrical contact (4) is connected to the braided hose (2), especially welded thereon.

8. A metallic or metallised braided hose, especially a stranded braided hose, comprising a quantity of solder or soldering and fluxing agent which is disposed in the interior of the hose and extends over at least one longitudinal section of the hose.

9. A metallic or metallised braided hose according to claim 8, characterized in that the quantity of soldering and fluxing agent is a cored solder wire with a core made of fluxing agent.

10. An apparatus for carrying out a method according to claim 1, characterized in that a receiving unit is provided for a metallic or metallised braided hose (1; 2), which exposes a cross-sectional opening of an end of a cavity (3) of the hose, a solder feed mandrel (6) is formed which can be moved with its mandrel end to the cross-sectional opening, a cored solder wire can further be brought mechanically via the interior of the solder feed mandrel (6) into the cavity (3) of the hose, and comprising at least one roller or press to apply a deformation force (A; B) in order to obtain a fixed bond between the cored solder wire (5) and the braided hose (1; 2), and comprising means (X) for cutting the bond to length.
